(19) United States
(12) Patent Application Publication
(10) Pub. No.: US 2008/0320378 A1
(43) Pub. Date: Dec. 25, 2008

(54) Accelerated Visual Text to Screen Translation Method

(76) Inventors: Jeff Shuter, Milwaukee, WI (US); Daniel Viney, Hollywood, CA (US)

Correspondence Address: STEFAN KIRCHANSKI, VENABLE LLP 2049 CENTURY PARK EAST, 21ST FLOOR, LOS ANGELES, CA, 90067, US

(21) Appl. No.: 12/091,103

(22) PCT Filed: Oct. 20, 2006
(86) PCT No.: PCT/US2006/060122

§ 371 Date: Sep. 10, 2008

Related U.S. Application Data
(60) Provisional application No. 60/728,986, filed on Oct. 22, 2005.

(51) Int. Cl. G06F 17/00

(52) U.S. Cl. 715/203

(57) ABSTRACT

A method of communicating, translating and producing digital visual texts. The inventive method prescribes the translation of a common set of visual conventions occurring in printed visual texts into rhythmic sequential arrangements on screen. These are constructed in synchrony with a carefully designed audio track. The sequential images and audio track create a ‘reading rhythm’ which guides and controls the rate at which a user reads and understands the visual text. Through this modal approach, the method is able to offer a common response to two separate demands identified in the current digital media landscape: (1) The need for an intelligible and durable aesthetic form for print-based visual-texts and sequential art when delivered and accessed in a digital format; and (2) The demand for video content that is both aesthetically and functionally appropriate for the unique viewing conditions and limitations inherent to digital media player devices.

### CROSS-REFERENCE TO PRIOR APPLICATIONS

This application is the non-provisional version of and claims benefit and the priority date of Provisional Application No. U.S. 60/728,986 with filing date of Oct. 22, 2005 which is incorporated herein by reference.

### BACKGROUND OF THE INVENTION

1. Area of the Art

This invention relates generally to methods of producing and communicating visual texts, and, more specifically, to methods of translating visual text into screen based content, and a production process for creation of content utilizing those methods.

2. Description of the Prior Art

Visual texts and sequential art have a long history in the United States, and throughout the world. Generally speaking, visual texts and sequential art refer to print based works that communicate to readers through a recognizable interplay of images and text. Examples include comic-books, graphic novels, children's picture books, instructional guides and text books. These printed visual texts and sequential art are an established form of ‘portable’ handheld visual media capable of the transmission of complex ideas and narratives. These ideas or narratives may take the form of a fictional or nonfictional story written to entertain the reader or as a lesson plan or instruction on a particular topic.

Due to their popularity and effectiveness at communicating information, use of visual texts has become widespread. This, coupled with the demand for content resulting from the emergence of digital portable media player devices, has resulted in attempts by entrepreneurs, artists, and other individuals to adapt visual texts into a medium capable of being delivered to these digital devices. These attempts can generally be grouped into four categories: repurposed print, multimedia comics, partial animation, and visual texts with experimental interfaces.

In the ‘repurposed print’ method of creating digital visual texts, the visual text is digitally reproduced exactly from an original print copy or is created using the constraints of print technology as a framework. The ‘page’ of the visual text is displayed statically on a screen. Usually the page requires some re-sizing in order to fit into the screen's dimensions. The borders of the screen work as if they are borders of the printed page. If the comic is longer than one page, the user advances through the comic at his or her own pace by progressing through new screens in a similar fashion to turning the pages of a book. For the delivery of comic-books, sometimes the printed page is broken down into individual panels which are then displayed as entire screens. In this model, the user advances through the comic-book on a panel-by-panel basis rather than page-by-page.

The ‘repurposed print’ category was one of the earliest methods of delivering digital visual texts and is still widely used today both for the adaptation of existing print works and the creation of original content for the screen. It is successful precisely because it does not attempt to differ from the proven print model and is read by the user in a manner very similar to that used for reading printed publications. However, remaining within the boundaries of print technology can also be a limiting factor. This style of delivery cannot easily offer an advantage over printed publications and has to contend with legibility issues such as low-resolution screen displays and, in the case of portable media players, small screen dimensions. The comic-book variation of the model where the individual panels are displayed onscreen one-by-one has largely fallen out of favor. This is because it cannot communicate the spatial relationship between individual panels which is an integral part to how comic-books communicate ideas to the reader.

‘Multimedia’ visual texts seek to ‘enhance’ traditional format visual texts or comic-books with interactive digital audio or visual add-ons. They operate by supplementing the ‘repurposed print’ model. The reproduced pages of the visual text are displayed on screen in the usual way. The user is then prompted to interact with the static images to produce additional effects that illustrate the content. These effects might include audio dialogue playback to accompany printed text or the limited animation of an image inside a panel often in response to some action by the user.

‘Partial animation’ takes the idea of multimedia comics one step farther, wherein the visual text is broken up and reformatted in a linear order so as to resemble traditional full-motion animation. Static panel images are displayed like scenes in a film or television show. The static objects within the panel images are then partially animated using techniques such as animating character mouth movements and superimposing the movements over the artwork. Dialogue and sound effects accompany the images as they would in traditional animation, despite the fact that the images contain limited motion. The user does not control the progress of the visual text and watches it much as they would watch traditional style video content.

The ‘multimedia’ and ‘partial animation’ categories have undergone more criticism than other delivery methods and are seldom used. Limited animation is a poor substitute for full animation. By trying to become like traditional full-motion animation, ‘partial animation’ is trying to live up to something it can never attain. ‘Partial animation’ also suffers from the fact that it usually works on a panel-by-panel approach which, as mentioned earlier, is problematic because it obscures the relationship of one panel to the next.

Visual texts with ‘experimental’ interfaces includes visual texts and comic books that are communicated on a screen without any of the framework inherited from print technology. The user is in control of navigating through the sequence of juxtaposed images and text. Examples of these types of digital visual texts can be as simple as a slight modification to the ‘repurposed print’ category where page layouts are not-resized to fit the screen exactly and the user is required to interactively ‘scroll’ or ‘zoom’ through the page. More complex examples remove the print technology concept of the ‘page’ and require the user to move through the visual text in a space that extends beyond the screen boundaries using a variety of idiosyncratic interfaces.

In theory, visual texts using experimental interfaces encourage the user to engage with the visual text in a manner similar to how he or she would interact with a printed visual text. The user is left to interpret and connect the spatial juxtapositions of images at a pace that he or she controls. Where the interface is simply a way to scroll and zoom around a reproduced print-style ‘page’, the screen becomes a limiting factor as it cannot represent something that should be viewed in its entirety. For more idiosyncratic navigational interfaces, the limitation is that the user is forced to learn a new set of aesthetic principles in order for the visual text to communicate successfully. Often, the user is also required to do this at the same time he or she is trying to actively follow the visual text's message. This can place a substantial burden on the user and is a barrier to the visual text's casual use. If the user is unable to decipher the interface mechanism, the resulting visual text can seem enigmatic and will fail to effectively communicate ideas to the reader.

Moreover, the characteristics of portable digital media players exacerbate the inherent limitations of the repurposed print, multimedia, partial animation, and experimental interface models of adapting visual texts to digital delivery systems. For instance, the viewing conditions for portable media players are usually not ideal. As a result, it is unlikely the user of the device will become immersed in the content in the same way they are when watching a conventional television screen or a theatrical film presentation. In addition, the small screen limits detail, and it becomes more difficult to convey the subtle nuances of motion that are important cues to the user in creating an engaging representation of “reality.” Even with impending technological advances in sound and picture quality, the limitations imposed on portable media player devices by the size of their screens and their uncertain viewing conditions will always likely remain constant.

### SUMMARY OF THE INVENTION

Therefore, it is an object of the current invention to overcome the aforementioned limitations of the prior art, and provide methods for communicating visual texts to a user in a digital format, and a process for producing these digital visual texts. At their foundation, the inventive methods assume the viewing conditions and usability associated with portable digital media players to be much more like reading print than watching film or television. Portable media players, such as cellular phones, personal data assistants (PDAs), portable music players, and portable game consoles, have much the same handheld relationship to the viewer as that of a book or other print media. Both are handheld, of similar size, and require the same level of interaction with the user.

The invention makes use of a valuable feature of visual texts to help negate the effect of the distracting viewing environments that often characterize use of portable media players. Reading prose or a visual text is an ‘active’ experience, where the user is required to derive meaning from the relationship between images and text. The user becomes a participant in the process. In contrast, watching film or television style content is a ‘passive’ process where the user is encouraged to mentally ‘switch off and become immersed in the experience.

Like printed visual texts, content produced by the invention is ‘read’ and not ‘watched’. By forcing a user to ‘read’ the visual text and extrapolate the overall message of the words and text, the inventive method occupies the cognitive functions of the user keeping the user's attention in an ‘active’ state. Because media produced by the inventive method more ‘actively’ engages the user, it prevents the user from becoming distracted by a busy viewing environment or the limitations of the portable media player.

At the same time, content produced according to the invention does not forcibly ‘seize’ the users attention by using gaudy eye-catching techniques and content as do other types of mobile video programming. Instead, it ‘solicits’ the users attention by engaging the user to be a ‘participant’ in the viewing process. In this way it is able to convey more complicated and in-depth information, as do printed visual texts. The invention accomplishes this through the construction of a ‘reading rhythm’ designed to replace the natural pace that a user reads a visual text. The Invention does not attempt to ‘animate’ the static images from the visual text over time. Instead it ‘dynamically rearranges’ the spatial arrangement of the images and text within the boundaries set by the screen.

To create a reading rhythm, the inventive method prescribes the translation of a common set of visual conventions into rhythmic sequential arrangements on screen. These are synchronized to a carefully designed audio tempo. The user still ‘reads’ the visual text as they would a read a printed version. The difference is that the ‘reading rhythm’ created by the dynamic image/text arrangement and audio tempo guides and controls the rate of users acquisition of information. Through this modal approach, the inventive method is able to offer a common response to two separate demands identified in the current digital media landscape: (1) the need for an intelligible and durable aesthetic form for print-based visual-texts and sequential art when delivered and accessed in a digital format; and (2) the demand for video content that is both aesthetically and functionally appropriate for the unique viewing conditions and limitations inherent to portable media player devices.

The second part of the inventive technology is a unique and scalable production process designed specifically for the creation of content that utilizes the inventive method of communicating digital visual texts. The invention was developed for the adaptation of existing print-based visual texts but can also be used for the creation of original content. Likewise, although the invention's formula is a natural fit for portable media players, the methods it contains could also be used to adapt and create content for distribution on larger format screens such as television and even theatrical projection.

### DESCRIPTION OF THE FIGURES

FIG. 1 illustrates the sequence in which panels of Western and Eastern visual texts are to be read.

FIG. 2 illustrates how time can be compressed or expanded based on the frequency and size of panels in a visual text.

FIG. 3 is a depiction of the stage, corresponding to the screen of a digital media player, on which Image and Type objects are displayed according to the inventive translation method.

FIG. 4 is an example of a page of a visual text that is to be translated into a digital visual text using the inventive method.

FIG. 5 is a representation of the visual text shown in FIG. 4 translated into a digital visual text according to the methods of the invention.

FIG. 6 is an example of a sequence map created according to the inventive method to define the sequence of image and type objects appearing on the stage.

FIG. 7 is a flow diagram of one embodiment of an inventive process for producing visual texts that follow the inventive translation methods.

FIG. 8 illustrates the derivation of points of interest within a rectangle having a certain aspect ratio.

FIG. 9 illustrates a method of resizing the stage of the inventive translation method from one aspect ratio to another.

### DETAILED DESCRIPTION OF THE INVENTION

The following description is provided to enable any person skilled in the art to make and use the invention and sets forth the best modes contemplated by the inventor of carrying out their invention. Various modifications, however, will remain readily apparent to those skilled in the art. The current invention is directed to a method of communicating visual texts in a digital format, and a method of producing digital visual texts in the inventive format.

Visual texts communicate narrative and instructional content by relying on a user understanding the known conventions of their spatial construction. As a result, to fully understand the essence and scope of the current invention, an explanation of these conventions is required.

Because print is a static medium, the passage of time can only be implied in visual texts. Accordingly, the passage of time is inferred from structural elements in visual texts, particularly narrative texts such as comic books, and is usually represented visually through the use of space. For example, comic books fracture time and space into rhythmic arrangements of ‘frozen’ moments. These ‘moments’ can take many forms, but most are represented by panels, which are blocks of visual and textual information on a page. The page itself can also be considered a ‘panel’ and is sometimes used as one. In this way, a printed comic book has two levels of panels. The pages that make up the comic and the panels contained within a page.

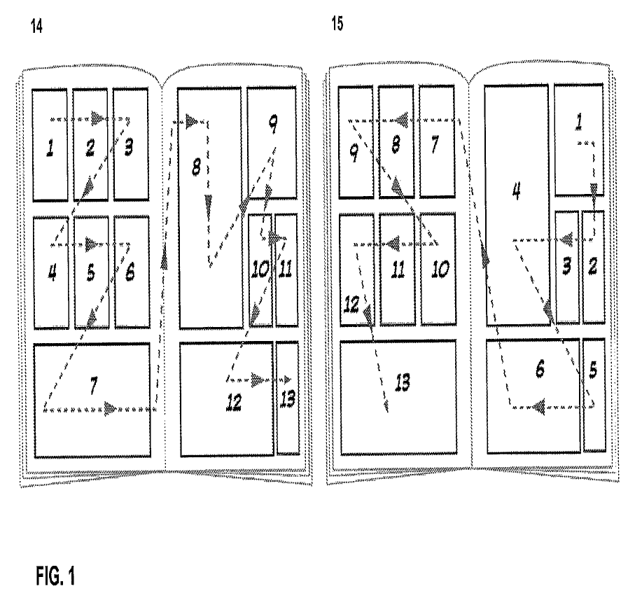

To progress forward through the ‘frozen’ moments represented by the panels, the panels must be read in sequential order. FIG. 1 illustrates the sequential order that pages, panels and their associated speech balloons are arranged in a comic book. As can be seen, a reader starts at panel 1 and progresses through the panels sequentially until they reach the end of the page at 13. Aside from the difference between Western 14 and Japanese 15 style visual texts, this arrangement is a convention that the reader is expected to know. Within a panel, speech balloons are read in left-to-right order in the West and right-to-left order in Japan.

The exact manner in which a reader will process a page cannot be predicted for certain. Convention assumes that first the reader scans the entire page of panels to form an overall image and then reads through each panel in the prescribed sequential order. The reader may also refer back to previous panels and images when necessary. In this way, the reader is not restricted to just seeing the panel he is currently reading. Unlike watching film or television, the reader is also able to view the moment in time before and after the moment they are acquiring. This is a necessary feature for comic books to work successfully.

Because visual texts can only imply time, the reader is left to construct the uninterrupted flow of time behind the visual text's narrative. The reader understands the time changes depicted in panels as well as the time period elapsed between the panels. To be able to construct a common unit of time and space in this way, the reader needs access to not just one panel in a sequence but a whole group of them. The reader's ability to interpret this spatial arrangement of images is fundamental to the comic books' success in communicating.

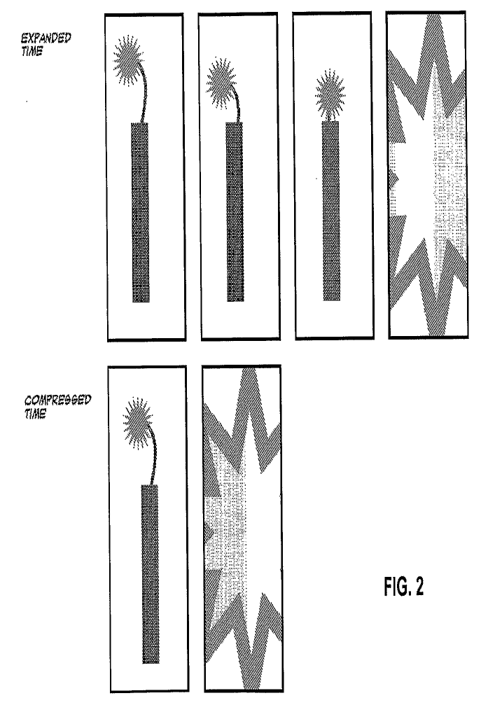

Comic books can do more than just convey the passage of time. They also have means to convey ‘timing’ or meter to alter the pace of the time and narrative action. Panel size, frequency and arrangement on a page forms a spatial rhythm, affecting the pace that the reader reads through the panels, and the rate of implied time change. In one respect, each panel can be thought of as a musical ‘beat’, and the arrangement of panels on the page and panel size set the tempo. Panels of the same shape in a row represent a constant steady rhythm. This can be broken by introducing panels of different shapes and sizes. Larger panels are often thought to imply more space and time. Large panels are also often used to perform a visual punctuation that reflects a change in location or implied time. As a result, time can be compressed and expanded by altering the size, shape, or number of the panels. For an example, refer to FIG. 2 which contrasts expanded time (top row) with compressed time (bottom row).

Although the careful arrangement of images in space is the principal way of controlling the flow of time depicted in comic books, there are several other ways time can be established. The most standard is through the use of written text. In the case of speech, the act of reading dialogue adds a certain time length to a panel. The end of the dialogue usually terminates the panel as the center of the readers focus.

Images contained within panels are also constructed so that they imply a certain amount of time rather than just a ‘frozen’ moment. A character will typically be rendered in the middle of an action that clearly defines what his or her previous and future actions were/will be. The images are also constructed so that they bear clear relation to other images contained within the sequence of panels. This juxtaposition means that additional meaning can be added to one panel from the panels that surround it.

In addition to the representation of time in comic books and other visual texts, the text in comic books or other visual texts can work in different ways than it does on its own. Text is not limited to simply describing the content of an image. Text and imagery can work in tandem to add additional meaning to the idea conveyed. Words are also able to add a level of precision to meaning that can only be inferred in imagery. Text can also be used to make sound more real by representing sound effects.

Expressive conventions are important in visual texts, particularly comic books. In the effort to depict elements than have no tangible visual presence, comic books have built up a series of visual expressive conventions. An example of one of these expressive conventions, perhaps the most obvious, is the speech balloon. This attempts to make visual something than has no visible presence—speech. Other examples include ‘motion lines’ to convey motion, and various effects that attempt to convey character emotion. Even the border of panels can take on an expressive abstract form.

The inventive method manipulates these conventions in a novel way to create a reading rhythm accelerating the communication of visual texts in a digital format. This ‘reading rhythm’ is the building block of the Invention's visual text to screen translation method. It functions to guide and direct the user's assimilation of the visual text within the boundaries of the screen. The ‘reading rhythm’ replaces the natural pace that a user would read through a visual text.

The ‘reading rhythm’ created by the invention can be thought of as taking most of the work out of physically reading a visual text such as a comic book. When reading a comic book, the user scans his or her eyes first over the page as a whole and then over the individual panels. The user does the work and eye ‘movement’ necessary to assimilate the images and text. With the inventive method, the user's eyes remain static and fixed on one location—the screen. The images and text are moved into dynamic arrangements on the screen, in effect performing the eye ‘movement’ for the user. The dynamic arrangements are intended to mirror the relationships between images and text that a user makes when scanning a printed page with their eyes.

In order to construct the ‘reading rhythm’, one must apply a physical dimension of time to the comic book. This applied time is constructed by determining a sequence that will structure the spatial image/text arrangements and then applying an actual time value to this sequence. The inventive method uses sound and motion—two elements that must inherently have a property of time—to control the actual time it takes a user to read the visual text. It is important to clarify, however, that the inventive method does not attempt to construct or manipulate the ‘narrative’ time of the visual text when applying a physical dimension of time. Rather, the applied time seeks to accelerate the time that it takes the user to assimilate and understand the visual text. As in reading a printed visual text, media made according to the inventive method leaves it up to the user to construct in his or her imagination the actual ‘narrative’ time from the cues the visual text provides.

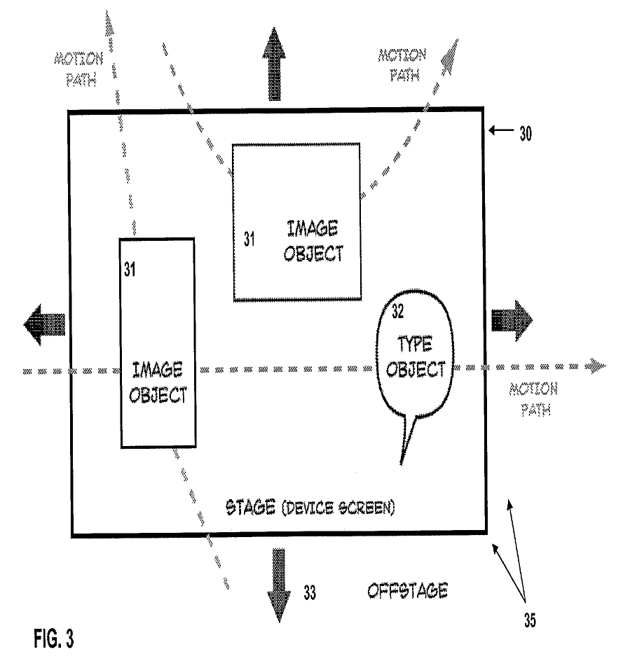

In one embodiment, the sound and motion used by the inventive method to keep the reader synchronized with a desired ‘reading rhythm’ exists almost entirely within a ‘stage’ 30, shown in FIG. 3. This ‘Stage’ 30 is a space where Image Objects 31, such as panels, or characters, Type Objects 32, such as thought or text balloons, and Expressive Objects (not pictured), such as motion lines, blurs, “stars,” and similar expressive graphic conventions, (collectively referred to as ‘Objects’) are dynamically arranged in relation to each other. In a preferred embodiment, the stage 30 can correspond to the visible part of a digital media player's screen. The edges 35 of the stage/screen 30 may be considered absolute, or, alternatively, they may be treated as extending indefinitely. In one embodiment, the inventive method treats the space beyond the screen as extending indefinitely, and refers to it as Off-Stage 33.

Objects' are arranged on the stage 30 in patterns according to their spatial properties in the original visual text. Objects can be arranged two dimensionally on the stage 30, or, alternatively, the objects can overlap, effectively making the stage 30 a three dimensional space. Moreover, the arrangement of Objects on the stage 30 is dynamic. Objects can move on or off stage in a variety of ways. For instance, Objects may move off one of the edges 35 of the stage, and can later reappear from the same or a different edge. Alternatively, Objects can appear suddenly, fade in or out, or move in from the background or the foreground. Expressive objects, such as motion lines, color changes, and expressive words, can also move or appear on the stage 30 to emphasize or accentuate a feature of the visual text. In one embodiment, expressive objects may be animated to sufficiently emphasize a feature within the visual text. One example of this animation is the creation of dynamic motion lines, conveying the speed or movement of an image object within the stage 30. Although objects can be animated, most movement consists of translation of the object in one or more directions across the stage.

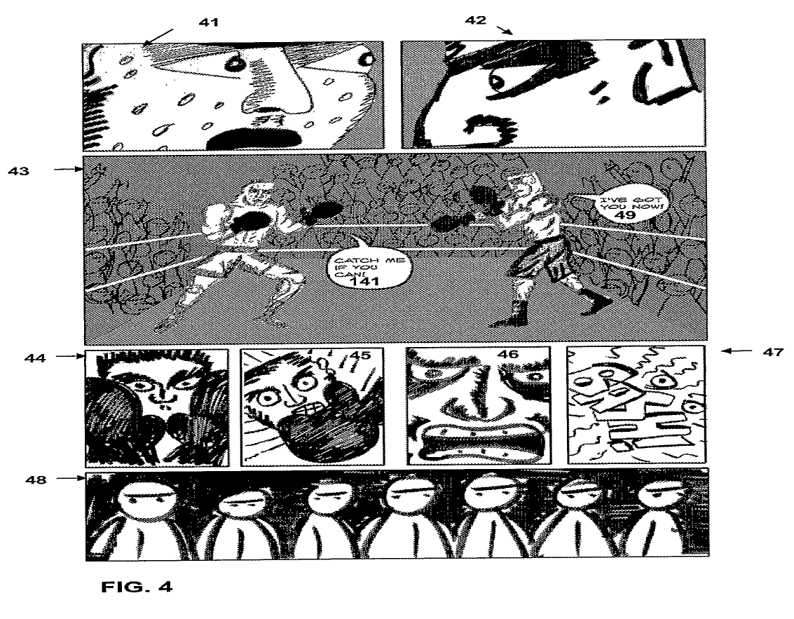

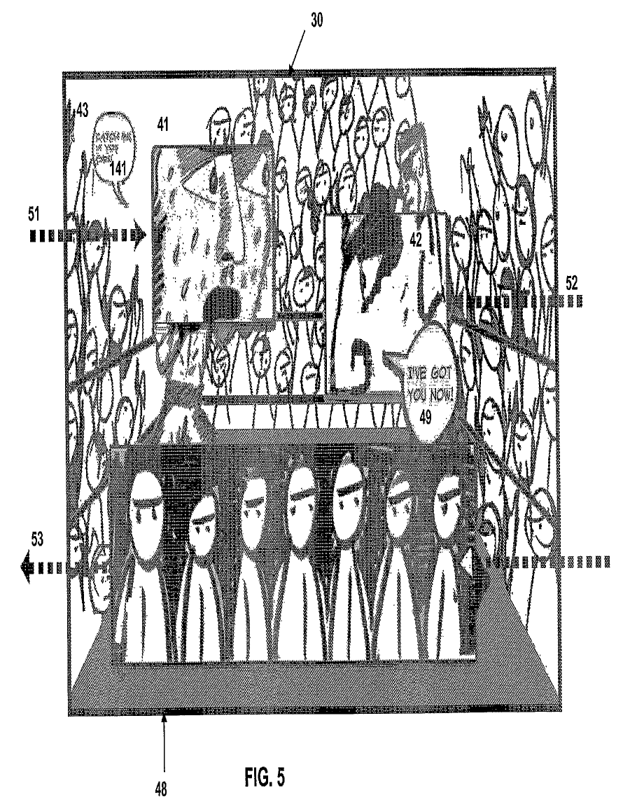

An example of translating a printed visual text, shown in FIG. 4, according to the inventive method is shown in FIG. 5. As can be seen, the panels of the printed visual text 41-48 can be dynamically arranged on the stage 30 of the inventive method. In this example, panel 43 is set as the background for the stage 30, and the remaining panels illustrate the narrative of the visual text by moving over the stage 30. As previously discussed, panels 41-42 and 48 can move across the stage 30 in a variety of ways, but in this example they move according to the arrows 51-53. In addition, to the Image objects 41-42, 48 a text bubble 49 is also dynamically arranged on the stage 30. The text bubble 49 can move over the background independently, or, as shown in FIG. 5, it may be associated with one of the panels 42. Moreover, Image 31, Type 32, or Expressive Objects need not be contained within a panel when moving across the stage. For example, the border around the boxer's face in panel 42 can be removed just leaving an image of the boxers face moving across the stage 30. Likewise, text may be placed outside a Type Object 32 according to the preferences of the user.

In addition to the arrangement of Objects on the stage 30, the pacing and speed at which the Objects move over the stage 30 can also vary according to the layout of the printed visual text and the preferences of the user of the inventive method. For example, a group of even shaped panels, such as 44-47, can translate into a steady flow of ‘Objects’ according to a constant geometric rhythm. Alternatively, to better illustrate the jarring and sporadic nature of the boxing match, the panels appear on the stage 30 sporadically. The speed at which Objects move across the stage 30 can also vary according to the narrative of the visual text or the preferences of the user. In some circumstances, such as in FIG. 5, Objects can move across the stage 30 rapidly to depict action. Alternatively, Objects may move slowly across the screen to depict a calm moment.

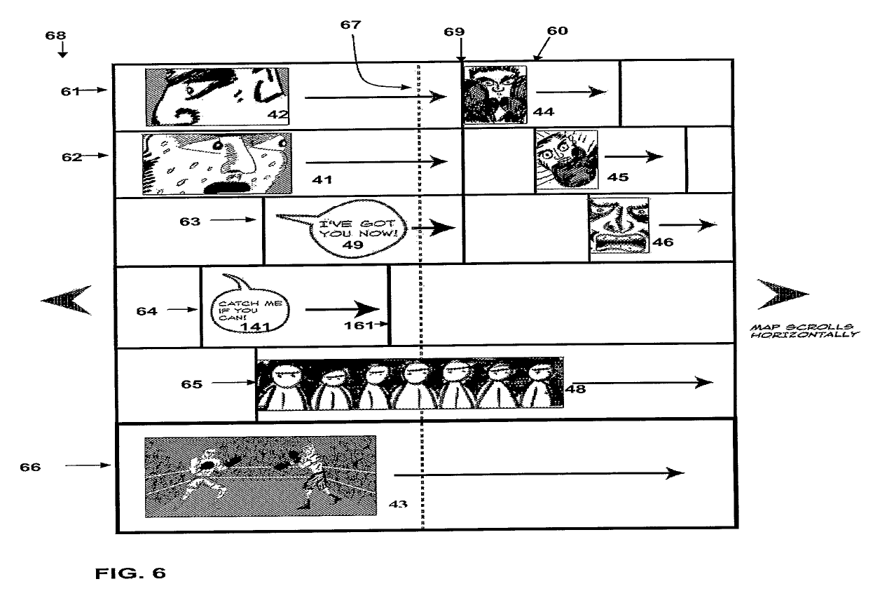

The flow of Objects on the stage 30, as described above and illustrated in FIG. 5, can be defined by a Sequence Map 60 shown in FIG. 6. A ‘Sequence Map’ 60 is the equivalent of a storyboard as used in film and television production. A sequence map 60 conveys the linear sequence of image and type ‘Objects’ without specifying an actual time unit. Since image and type ‘Objects’ are dynamically juxtaposed together by the inventive method, the ‘Sequence Map’ needs to go further than just communicating a ‘storyboard style’ sequence. It needs to relay the sequence that the ‘Objects’ overlap on the ‘Stage’. The ‘Sequence Map’ indicates these overlaps by layering the various ‘Objects’ on top of each other—somewhat like a musical notation. An example of this layering is shown in FIG. 6.

In one embodiment, shown in FIG. 6, the sequence map 60 defines when each Image or Type object comes on to the stage and how long it stays. For example, the portion of the sequence map 60 between the start, represented by line 68, and the dotted line 67 represents the objects on the stage during the scene depicted in FIG. 5. In this example, panels 41 and 42 both enter the stage 30 at the start 68 of the scene and remain on the stage 30 until 69, where panels 44 and 45 enter the stage. Panels 49 and 141 enter the stage 30 slightly after panels 41 and 42, at 63 and 64 respectively, and remain on the stage 30 until 69 and 161. Likewise, Panel 48 enters the stage 30 after panels 41 and 42 at 65, but panel 48 remains on the stage until the end of the portion of the sequence map shown 60.

The embodiment of the sequence map 60 shown in FIG. 6 does not explicitly convey the spatial arrangements of Image or Type Objects on the screen, or the types of motion that are applied to them. In alternate embodiments, sequence maps may contain some indication as to where the Image or Type object is located spatially, and whether or not the panel moves in some way. In the embodiment illustrated in FIG. 6, the sequence map ends up being a very long horizontal document. It is designed to be delivered digitally to production workstations where it is navigated through by horizontal scrolling on a computer monitor.

In addition to laying out the sequence of Image and Type Objects on the stage, the sequence map can also be used as a reference when incorporating sound into the translated visual text. The incorporation of spoken audio, music and sound effects can act as glue that synchronizes the visual and audio parts of the ‘reading rhythm’ together. Spoken words corresponding to Image 31 and Type 32 Objects are one device that the inventive method can use to move the reading rhythm forward and motivate the progress from one image arrangement to the next. For example, the audio corresponding to a text bubble may be played quickly, forcing a reader to quickly progress through a series of panels. In addition, spoken audio may be accompanied by visual cues within the Type object. For example, spoken audio may correspond to highlighting of the spoken words within speech bubbles on the stage. In alternate embodiments, the text may be revealed gradually synchronized with the spoken audio, or the spoken audio may correspond to a dynamic underline, bouncing ball, or other visual indication of the progress and location of the spoken audio.

Likewise, the underlying tempo of background music can act as a map for the exact placement of spoken dialogue and sound effects. The musical tempo is a guide for the user to keep in ‘beat’ with the ‘reading rhythm’ in much the same way as it is possible to keep ‘beat’ with a piece of music. The timing of the motion that moves ‘Image Objects’ from one location to the next is done in sync to this tempo. The exact style of the music is a creative decision and is done in reaction to the creative demands of the comic book. Sound effects can also be used in the Invention to reinforce the pace of the reading rhythm. Sound effects can be worked into the overall musical composition and each one can be placed exactly on a beat of the background music. Sound effects are very important in timing the motion of ‘Objects’ on the stage. They act to guide the timing of motion and often provide cues to motivate the movement of ‘Objects’

The audio component of the inventive method can be used according to the preferences of the user. In some embodiments, the user may decide that spoken dialogue, sound effects or music are not required in the translation of the visual text. In alternate embodiments, these elements may be crucial in controlling the pace at which a reader digests the narrative or other information presented by the visual text.

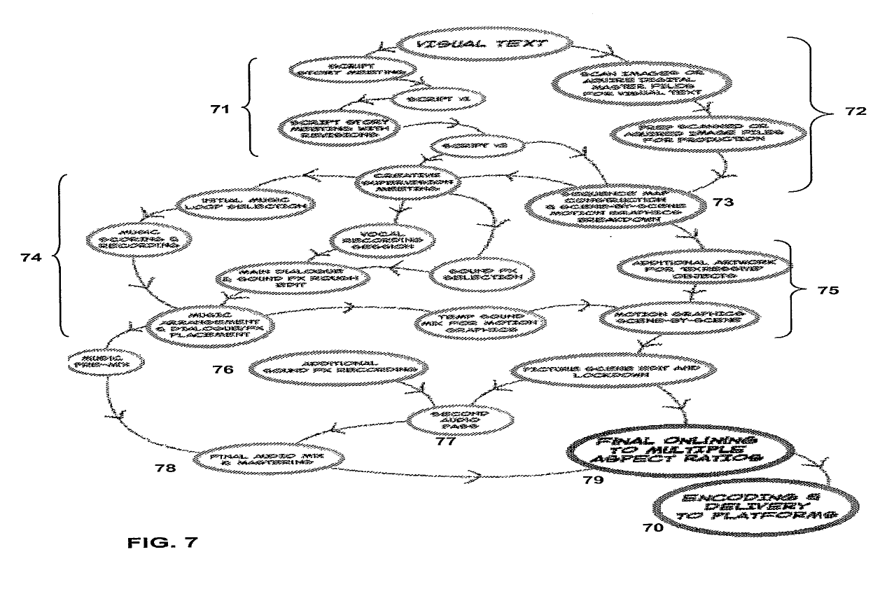

In addition to a method of translating a printed visual text to a format suitable for play on a digital media player, the invention also prescribes an optimized production process for producing content using its methodology. This production process is scalable from production using a small two person team through to mass production. In one embodiment, content produced by the Invention follows series of steps outlined in FIG. 7, and described in the following paragraphs.

In this embodiment, the production of a digital visual text involves the creation of a standard script from a source visual text according to the steps show at sign 71. In alternate embodiments, an original script, not relating to any existing visual text, may be created. The script may, or may not, convey the amount of the visual text that will be converted into the digital visual text, and/or can act as the script for the vocal recording of dialogue or narration. Once the script is created, the images for the digital visual text must be acquired in the steps at sign 72. In one embodiment, the illustrations from the visual text are digitized from an original printed visual text and separated into discreet sets of image ‘objects’. Alternatively, a digital production file can be used, or original digital, or hand-drawn drawings may be created.

At step 73, a sequence map for the digital visual text is created from a script, an original visual text, a storyboard, or from the author's notes. As previously described, the sequence map acts as a storyboard indicating the sequence of objects during the actual time created by the inventive method, and can help guide the creation of the audio and motion that sets the reading rhythm of the digital visual text.

In the steps at sign 74 the background music, sound effects and audio dialogue, can be created to accompany the digital visual text. This audio can be created from the script or the original visual text, or can be originally produced, or derived from another source. The audio can then be edited together in sequential order, as opposed to being placed in absolute positions. The audio elements are also constructed in a carefully designed arrangement and tempo dictated by the inventive method so as to form the audio component of the guiding ‘reading rhythm’. The ‘Sequence Map’ can provide reference for the construction of the audio arrangement, indicating the sequence, groupings, motions, and expressive elements planned for image and text ‘objects’.

Likewise, the sequence map can also be used as a reference when designing the motion used to set the reading rhythm of the inventive translation method as shown in the steps at sign 75. Images and text from the ‘Sequence Map’ are put onto motion paths which are given actual time lengths by cues placed on the completed audio arrangement. In alternate embodiments, a universal time scale may be created in which the audio and motion, or other visual cues, are set to. Moreover, ‘Expressive’ objects within the visual text can also animated or embellished with artwork at this stage. The exact nature of the motion and use of expressive objects is a creative reaction to the visual text and is not defined by the Invention.

In one embodiment, a second level of sound effects is created for the digital visual text produced according to the methods as indicated at step 76. In an ideal production line, the communication between the audio and visual development would be efficient enough for this step not to be necessary. In practice, however, some motion paths need to be constructed without sounds in place in the audio arrangement to underscore them. On a second audio pass at step 77, additional sounds are added in to make up for this.

In one embodiment, the produced digital visual text is configured for target digital media player devices. For example, once all the audio is in place for the digital visual text, the soundtrack is mixed in formats appropriate to the target devices at step 78. Moreover, the final visuals can be rendered in a plurality of aspect ratios, which are compatible with different target devices, and combined with the final mastered sound at step 79. The digital visual text, and audio accompaniment, can then be encoded and delivered for use on the targeted devices at step 70.

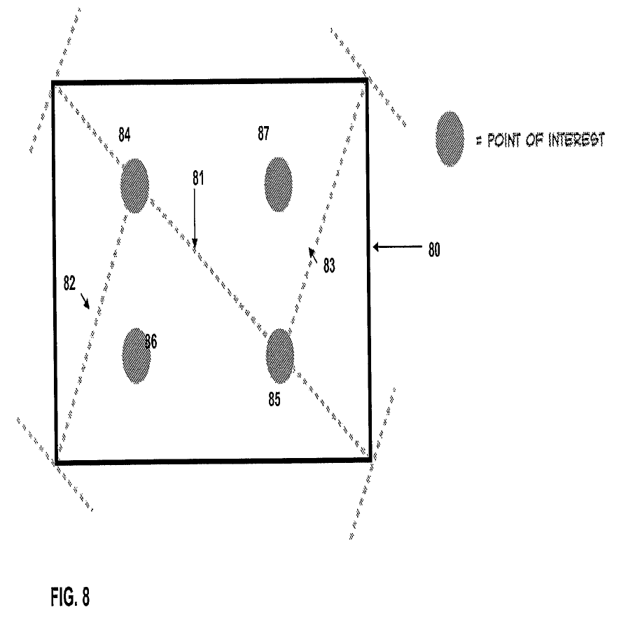

In one embodiment, the step of rendering the digital visual text into a plurality of aspect ratios occurs through the process of aspect ratio morphing. This technical method is developed for use in the inventive production process, and it makes it possible for content to be created for one screen aspect ratio and be easily converted to the variety of different screen aspect ratios without the proportional distortion or cropping of the content within it. As shown in FIG. 8, this method is based on the aesthetic and mathematical concept of rectangular shapes having points of interest which can be determined by dividing the shape's interior into proportionally related triangles.

The concept underpinning this method is colloquially known by such terms as the ‘golden proportion’, or the ‘rule of thirds’ when applied to photography. As can be seen in FIG. 8, four points of interest 84-87 within the rectangle 80 can be derived according to the following method. A diagonal 81 between the two corners of the rectangle 80 divides it into two triangles, each with congruent corresponding angles. The ratio of the short side to the long side of each triangle is 0.618 and the ratio of the long side to the short side is 1.618. To derive a first pair of points of interest within the rectangle, a perpendicular line 82, 83 is drawn from the far vertex to the diagonal. The point of intersection of each perpendicular line 82, 83 and the diagonal 81 define the first pair of points of interest 84, 85. This process is repeated to derive the second pair of points of interest 86, 87. The interior is now divided into several triangles of different size, but note that each is similar to the other, indicating that their corresponding sides are proportional and their corresponding angles are congruent.

In one embodiment, the invention treats the screen as a visible stage over which there are groupings of individual image objects and their vector motion paths that arranged in relation to each other, rather than in relation to the screen. To resize the aspect ratio of the screen, the inventive method locks objects to the nearest point of interest, derived according to the steps describe above, and moves the object relative to the movement of the point of interest.

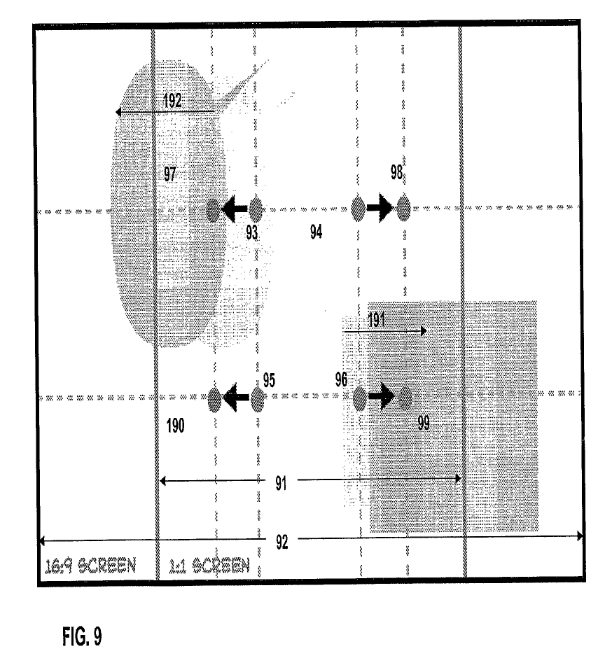

For example, FIG. 9 illustrates the resizing of a digital visual text from an aspect ration 91 of 1:1 to the a screen having a 16:9 aspect ratio 92, the size of most digital media players' screens. In this example, the four points of interest derived according to the steps described in reference to FIG. 8 can be seen at 93-96. The image objects on the stage are locked to the point-of-interest closest to them. To resize the contents of the image for display on a 16:9 screen, the points of interest move to new positions 97-99, 190 determined by the proportions of a 16:9 rectangle. As can be seen, the position of the image objects, and their corresponding motion paths, move 191-192 relative to the new location of the point-of-interest they were originally locked to. Likewise, the repositioned image objects are also resized according to the change in aspect, so that they remain in the same relative proportion to each other. The end result is a 16:9 layout that appears visually natural.

In alternate embodiments, other rendering techniques for converting a visual text from a first to a second aspect ration can be used. Moreover, the order of the production steps can deviate from the steps described above. In a preferred embodiment, the production steps follow the sequence described to achieve the optimized coordination between the visual and audio parts of the ‘reading rhythm’ construction. However, various modifications and/or improvements may be made to the production method.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

We claim:

1. A method for communicating a digital visual text comprising the steps of:
displaying image and type objects on a stage;
imparting motion to the image and type objects on the stage; and
playing a soundtrack corresponding to the motion and the digital visual text, wherein the soundtrack sets a pace at which a user reads the digital visual text.

2. The method of claim 1, wherein image and type objects are selected from the group consisting of panels, characters or objects from a panel, text, thought balloons, dialogue bubbles and expressive objects.

3. The method of claim 1, wherein the soundtrack is composed of elements selected from the group consisting of spoken dialogue, background music and sound effects.

4. The method of claim 1, wherein the soundtrack corresponds to the movement of image and type objects on the stage.

5. The method of claim 1, wherein the movement of image and type objects comprises translation of the objects across the stage but does not include animation of the content of those objects.

6. The method of claim 1, wherein the image and type objects are displayed, and the soundtrack played on a digital media player.

7. The method of claim 6, wherein edges of the stage correspond to edges of a screen of the digital media player.

8. A method of translating a printed visual text to a digital visual text for display on a digital media player comprising the steps of:
creating a sequence map for the digital visual text, wherein image objects, type objects and motion appearing in the visual text are sequentially arranged;
providing a stage for displaying image and type objects from the visual text;
displaying image and type objects on the stage, and
playing audio while the image and type objects are displayed, wherein displaying the image and type objects and playing audio create a reading rhythm for a user reading the digital visual text.

9. The method of claim 8 further comprising a step of moving the image and type objects across the stage to reinforce the reading rhythm of the digital visual text.

10. The method of claim 8, wherein image and type objects are selected from the group consisting of panels, characters or objects from a panel, text, thought balloons, dialogue bubbles and expressive objects.

11. The method of claim 8, wherein the audio played is selected from the group consisting of spoken dialogue, background music and sound effects.

12. The method of claim 9, wherein the audio corresponds to the movement of image and type objects on the stage.

13. The method of claim 12, wherein the audio played is selected from the group consisting of spoken dialogue, background music, sound effects and combinations thereof.

14. The method of claim 8, wherein the edges of the stage correspond to the edges of a screen of the digital media player.

15. A method of producing a digital visual text to be displayed on a digital media player comprising the steps of:
acquiring images for the digital visual text;
creating a sequence map for the digital visual text, wherein image objects, type objects and motion appearing in the visual text are sequentially arranged;
providing a stage for display of the digital visual text, wherein the stage is a space on which the image and type objects appear;
arranging audio to accompany the image and type objects;
applying motion to image and type objects on the stage according to the sequence map; and
recording the motion in synchrony with the audio to create the digital visual text.

16. The method of claim 15, wherein the edges of the stage correspond to the edges of a screen of the digital media player

17. The method of claim 16 further comprising a step of rendering the proportions of the stage to an aspect ratio suitable for the digital media player.

18. The method of claim 17, wherein the step of rendering the proportions includes repositioning and resizing the image and type objects appearing on the stage.

19. The method of claim 15, wherein arranging audio and applying motion create a reading rhythm for a user reading the digital visual text.

20. The method of claim 15, wherein image and type objects are selected from the group consisting of panels, characters or objects from a panel, text, thought balloons, dialogue bubbles and expressive objects.
